(19) United States
(12) Patent Application Publication
(10) Pub. No.: US 2026/0318823 A1
(43) Pub. Date: Oct. 15, 2026

(54) MACHINE-LEARNING-DRIVEN RAY-BASED NAVIGATION AND VIRTUALIZATION APPARATUS AND METHOD FOR TUNING QUANTUM DOT DEVICES

(71) Applicant: Government of the United States of America, as represented by the Secretary of Commerce, Gaithersburg, MD (US)

(72) Inventor: Justyna Pytel Zwolak, Point of Rocks, MD (US)

(21) Appl. No.: 19/656,417

(22) Filed: Apr. 23, 2026

Related U.S. Application Data
(63) Continuation-in-part of application No. 18/028,154, filed on Sep. 27, 2021.
(60) Provisional application No. 63/083,368, filed on Sep. 25, 2020.

(51) Int. Cl. G01N 21/27; G06N 3/0464

(52) U.S. Cl. CPC G01N 21/274; G06N 3/0464

(57) ABSTRACT

A ray-based single charge carrier navigation and virtualization apparatus for calibrating quantum dot devices includes a quantum dot device having qubit and charge sensor dots, a two-dimensional measurement unit for acquiring spatial stability data, and a ray measurement unit for executing targeted one-dimensional electrical probes. A controller coordinates a sequence of operational modules to autonomously configure the device. A detection module identifies anomalous charge traps using the spatial data. Unloading and checking modules depletes charge carriers and verifies a carrier-depleted baseline. A virtual gate calibration module derives virtual gates to establish orthogonal control axes. A loading module injects a target charge carrier configuration into the quantum dot device. An occupancy check module validates the target configuration. Finally, a virtual gate calibration module derived virtual gates calibrated to the target charge state.

### CROSS-REFERENCE TO RELATED APPLICATION

This application is a continuation-in-part and claims benefit of U.S. patent application Ser. No. 18/028,154 (filed Mar. 3, 2023), which is a national stage application filed under 35 U.S.C. § 371 of International Patent Application No. PCT/US21/52248 (filed on Sep. 7, 2021), which claims the benefit of U.S. Provisional Application No. 63/083,368 (filed Sep. 25, 2020), the disclosures of each of which are hereby incorporated by reference in their entirety.

### STATEMENT REGARDING FEDERALLY SPONSORED RESEARCH

This invention was made with United States Government support from the National Institute of Standards and Technology (NIST), an agency of the United States Department of Commerce. The Government has certain rights in this invention.

### BACKGROUND

The present invention generally relates to the field of semiconductor quantum dot device calibration and control, and more particularly to techniques for automating navigation to a desired few-charge-carrier regime using ray-based measurements, machine learning, and data-driven analysis.

Gate-defined semiconductor quantum dots constitute a promising platform for the scalable realization of quantum information processing architectures. Owing to their small physical footprint, alongside compatibility with advanced semiconductor manufacturing techniques, these structures offer a pathway toward realizing functional quantum computers. Researchers and engineers typically rely upon manipulation of individual charge carriers, confined within localized potential wells, to encode and process quantum information. Practitioners adjust an array of electrostatic gate voltages to establish the number of resident charge carriers and to mediate tunnel couplings with neighboring quantum dots or adjacent charge carrier reservoirs. Despite the promise of semiconductor-based qubit implementations, tuning a complex array into a functional operational regime presents experimental hurdles. Conventional calibration procedures depend upon iterative, manual adjustment of numerous gate voltages while a human operator interprets nuanced charge sensor data. These conventional practices are time-consuming, rely upon the intuition of experts, and fail to scale as the physical dimensions of the qubit arrays expand. Device nonidealities introduce complications that frustrate reliable control methodologies. Capacitive crosstalk between proximate metallic gate electrodes, stochastic drift in sensitive charge sensors, and the generation of unintended charge traps or spurious quantum dots severely disrupt the electrostatic environment. Attempts to alleviate this calibration burden have introduced various automated tuning methodologies, yet these approaches have vulnerabilities. Conventional automation paradigms demand the acquisition of extensive, highly detailed two-dimensional gate voltage scans to adequately assess the global state topology of the device. Classical optimization routines and preliminary machine learning classifiers deployed in these frameworks routinely exhibit brittleness when confronted with realistic experimental noise, unanticipated out-of-distribution device behavior, or dynamically shifting operating conditions.

It is therefore an objective of the present invention to provide a data-efficient apparatus that autonomously navigates between distinct operational regimes and precisely tunes a complex device to a targeted charge configuration, thereby overcoming the above-mentioned disadvantages of the prior art at least in part. Accordingly, a ray-based single charge carrier navigation apparatus using one-dimensional measurements and machine-learning virtualization techniques to establish reliable device controllability and unequivocally verify target charge occupancies would be advantageous and would be favorably received in the art.

### BRIEF DESCRIPTION

Disclosed is a ray-based single charge carrier navigation and virtualization apparatus that comprises a quantum dot device having qubit dots and charge sensor dots, a controller electrically coupled to the quantum dot device, a ray measurement unit electrically coupled to the controller, the ray measurement unit including a voltage controller and a data acquisition unit, a two-dimensional measurement unit electrically coupled to the controller, a spurious quantum dot detection module electrically coupled to the controller, a quantum dot device unloading module electrically coupled to the controller, an empty quantum dot check module electrically coupled to the controller, a virtualization enabling module electrically coupled to the controller, a virtual gate calibration module electrically coupled to the controller, a quantum dot loading device module electrically coupled to the controller, and an occupancy check module electrically coupled to the controller.

Disclosed is a process for autonomously tuning a quantum dot device using ray-based measurements that comprises acquiring a first 2D quantum dot device measurement data from a quantum dot device having qubit dots and charge sensor dots; extracting feature data from the first 2D quantum dot device measurement data using a machine learning system; generating fitted feature data from the feature data using a fitting unit; detecting an absence of a spurious quantum dot by applying domain heuristics to the fitted feature data; acquiring a first set of ray measurement data using a ray measurement unit; generating peak data from the first set of ray measurement data using a peak detection unit; acquiring a second set of ray measurement data using a ray measurement unit; generating peak data from the second set of ray measurement data using a peak detection unit; confirming that the empty state is achieved; acquiring a third set of ray measurement data using a ray measurement unit; generating peak data from the third set of ray measurement data using a peak detection unit; navigating to the first set of charge transitions using virtualization enabling module; acquiring a second 2D quantum dot device measurement data from a quantum dot device having qubit dots and charge sensor dots; extracting feature data from the second 2D quantum dot device measurement data using a machine learning system; generating fitted feature data from the feature data using a fitting unit; calculating a virtual gate using a virtual gate calibration module; acquiring a fourth set of ray measurement data using a ray measurement unit; generating peak data from the fourth set of ray measurement data using a peak detection unit; modifying a charge carrier occupancy of the quantum dot device along a direction of the virtual gate to load a target charge configuration; loading the desired charge occupancy module and verifying the target charge configuration of the quantum dot device by acquiring a fifth set of ray measurement data.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1A shows, according to some embodiments, a first portion of a flowchart of sequential logic and operations for a ray-based single charge carrier navigation and virtualization framework.

FIG. 1B shows, according to some embodiments, a second portion of the flowchart of sequential logic and operations for a ray-based single charge carrier navigation and virtualization framework.

FIG. 2 shows, according to some embodiments, a schematic block diagram of hardware architecture and procedural data flow traversing between a controller, measurement units, and analytical modules executing an automated tuning and virtualization sequence.

FIG. 3 shows, according to some embodiments, a process flow for a ray-based single charge carrier navigation and virtualization framework.

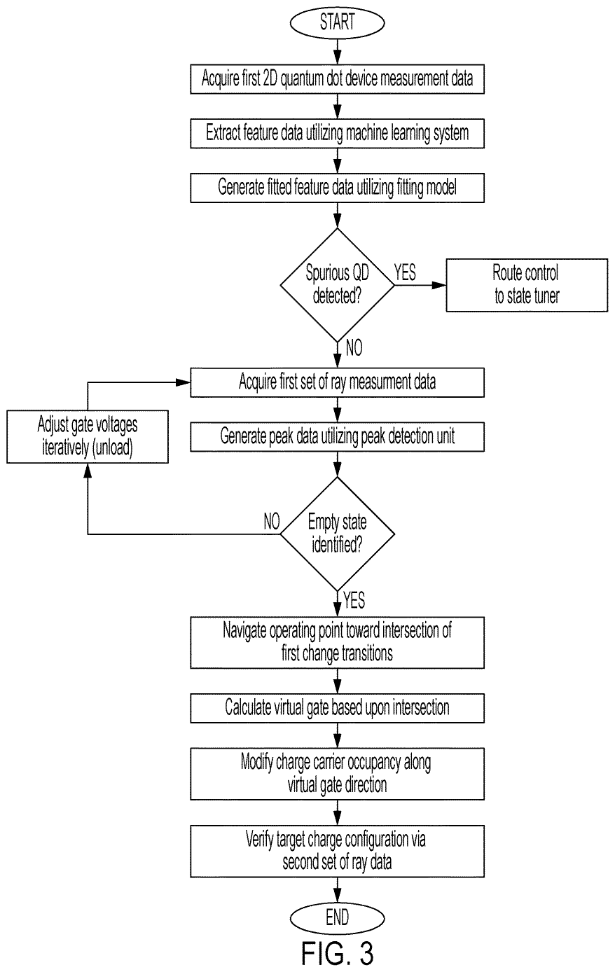

FIG. 4 shows, according to some embodiments, a system for control, data acquisition, and data analysis for a ray-based single charge carrier navigation and virtualization apparatus.

### DETAILED DESCRIPTION

Conventional semiconductor calibration protocols exhibit limitations when scaling toward dense arrays of sensitive electrostatic nodes. Human operators conventionally tune these complex architectures through exhaustive manual adjustments, relying upon subjective interpretations of nuanced sensor feedback. As the physical dimensions of the arrays expand, this conventional reliance on individual intuition becomes computationally intractable and temporally unviable. While conventional automated methodologies attempt to alleviate this enormous burden, they depend upon acquiring massive planar maps of the operational parameter space. These broad sweeps consume vast amounts of diagnostic time and routinely demonstrate severe brittleness in the face of stochastic device noise, shifting sensor baselines, or the sudden emergence of unintended charge traps.

The ray-based single charge carrier navigation and virtualization apparatus described herein overcomes these temporal and computational vulnerabilities plaguing conventional automation approaches. It has been discovered that a ray-based single charge carrier navigation and virtualization apparatus provides exceptional utility and enhanced performance by unifying targeted linear measurements with a suite of algorithmic units. By structuring the architecture to include a quantum dot device having qubit dots and charge sensor dots, the system anchors discrete quantum information nodes immediately adjacent to highly sensitive local electrometers. A controller electrically coupled to the quantum dot device establishes a robust, low-latency communication pathway for driving operations and receiving instantaneous feedback. It is contemplated that highly advantageous functionality emerges from integrating specialized measurement and analysis blocks directly into the central logic. A ray measurement unit electrically coupled to the controller, the ray measurement unit including a voltage controller and a data acquisition unit, executes sparse, highly targeted linear sweeps to conserve diagnostic bandwidth while synchronously capturing precise physical responses. To complement this targeted approach, a two-dimensional measurement unit electrically coupled to the controller supplies broader planar data when extensive spatial mapping is beneficial. To protect the integrity of the active electrical landscape, a spurious quantum dot detection module electrically coupled to the controller actively intercepts signals originating from anomalous potential wells, preventing subsequent automated routines from derailing.

The architecture provides operational baseline verification through rigorous charge carrier depletion logic. A quantum dot device unloading module electrically coupled to the controller decisively ejects all resident charge carriers, while an empty quantum dot check module electrically coupled to the controller confirms this absolute depletion to secure a reliable pristine state. Following this precise verification, a virtualization enabling module electrically coupled to the controller dynamically shifts the active operational domain toward a primary transition intersection. A virtual gate calibration module electrically coupled to the controller immediately resolves precise linear combinations of electrostatic potentials to neutralize crosstalk. Ultimately, a quantum dot loading device module electrically coupled to the controller manages the exact stepwise injection of target carriers, and an occupancy check module electrically coupled to the controller validates the final numerical distribution.

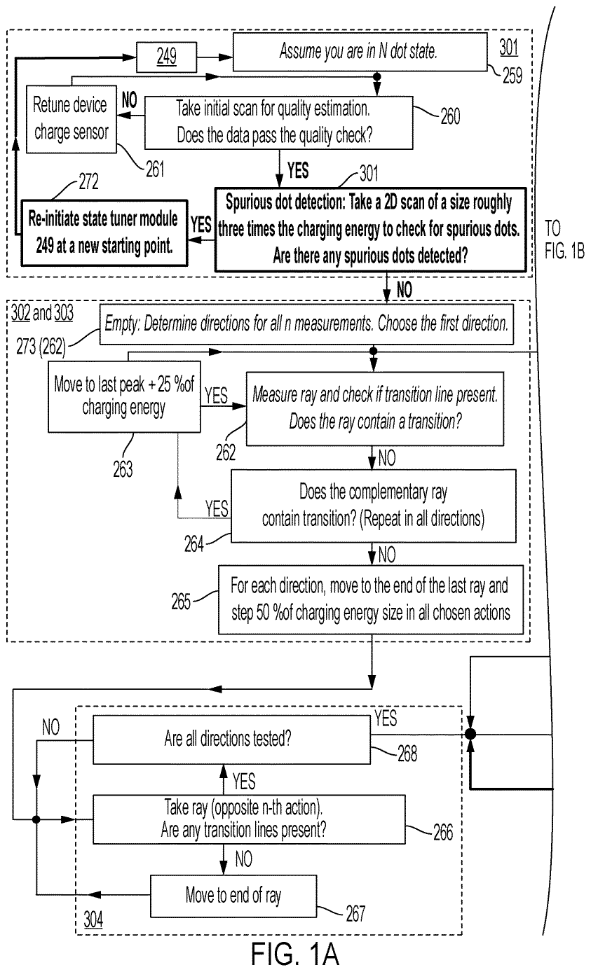

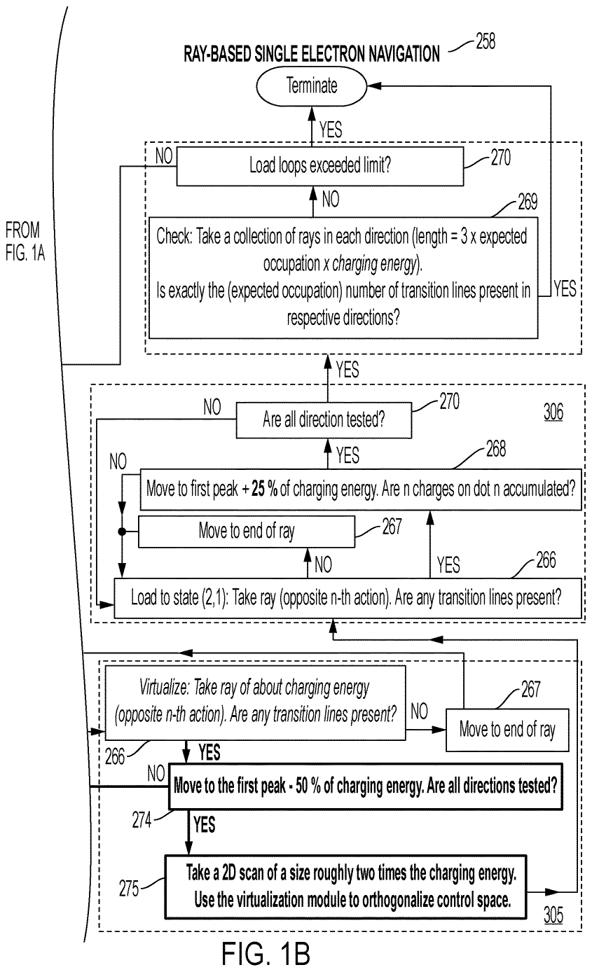

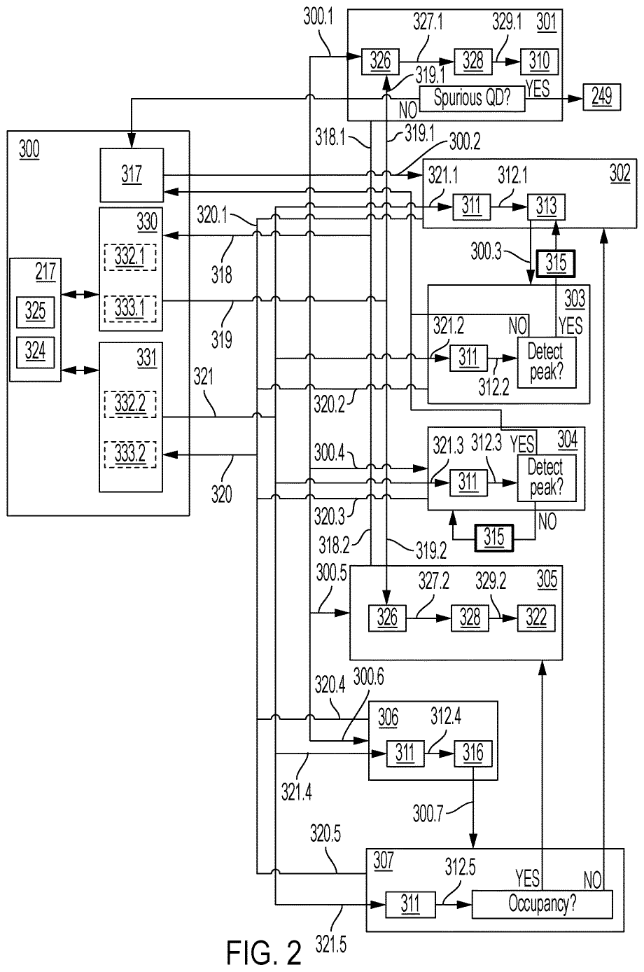

With reference to FIGS. 1 and 2, in an embodiment, a ray-based single charge carrier navigation and virtualization apparatus (200) comprises a quantum dot device (217) having qubit dots (325) and charge sensor dots (324); a two-dimensional measurement unit (330) comprising a voltage controller (332.1) and a data acquisition unit (333.1) configured to acquire spatial charge stability data from the quantum dot device (217); a ray measurement unit (331) comprising a voltage controller (332.2) and a data acquisition unit (333.2), configured to execute one-dimensional targeted electrical probes on the quantum dot device (217); and a controller (317) electrically coupled to the quantum dot device (217), wherein the controller incorporates: a spurious quantum dot detection module (301) configured to identify anomalous charge carrier traps based on data from the two-dimensional measurement unit (330); a quantum dot device unloading module (302) configured to iteratively adjust voltages via the ray measurement unit (331) to deplete charge carriers from the quantum dot device (217); an empty quantum dot check module (303) configured to verify a carrier-depleted baseline of the quantum dot device (217) via the ray measurement unit (331); a virtualization enabling module (304) configured to iteratively adjust voltages via the ray measurement unit (331) and the heuristic voltage adjustment unit (315) to bring the coordinate frame near the first set of charge transitions; a virtual gate calibration module (305) configured to derive based on the two-dimensional measurement unit (330) virtual gates to establish orthogonal control axes for the quantum dot device (217) using the virtual gates unit (322); a quantum dot loading device module (306) configured to inject a target charge carrier configuration into the quantum dot device (217) utilizing the established orthogonal control axes; and an occupancy check module (307) configured to validate the target charge carrier configuration utilizing the ray measurement unit (331). In an embodiment, the spurious quantum dot detection module (301) includes a machine learning system (326), a fitting unit (328), and a domain heuristic unit (310). In an embodiment, the controller (317) includes a microprocessor and a memory. In an embodiment, the charge sensor dots (324) include a quantum point contact. In an embodiment, the charge sensor dots (324) include a single-charge-carrier transistor. In an embodiment, the charge sensor dots (324) are integrated onto a common chip with the quantum dot device (217). In an embodiment, the two-dimensional measurement unit (330) includes a radio-frequency reflectometry unit (335). In an embodiment, the two-dimensional measurement unit (330) includes a low-frequency conductance measurement unit (336). In an embodiment, the machine learning system (326) includes a U-Net-based architecture and or a convolutional neural network (337).

In an embodiment, the ray-based single charge carrier navigation apparatus (200) coordinates a sequence of measurement and control phases to tune a quantum dot device to a desired charge carrier configuration. This electro-physical system implements a structured operational paradigm bypassing exhaustive multidimensional voltage sweeps. Instead, it leverages targeted linear measurements to map localized electrostatic boundaries. Such an arrangement curtails data acquisition times, offering superior performance metrics and preserving computational bandwidth. Various implementations might orchestrate the tuning sequence dynamically or rely upon pre-programmed linear sequences to accommodate disparate quantum architectures. In an embodiment, one deploys the ray-based single charge carrier navigation apparatus (200) to autonomously initialize dense semiconductor qubit arrays without human intervention.

In an embodiment, the quantum dot device (217) incorporates qubit dots (325) designed to localize individual charge carriers alongside charge sensor dots (324) that provide an electrical readout highly sensitive to proximal charge carrier occupancy changes. The charge sensor dots (324) may manifest as quantum point contacts or single-charge-carrier transistors. Integrating the qubit dots (325) and the charge sensor dots (324) onto a single solid-state platform establishes an intimate electrostatic coupling between the primary information nodes and the measurement electrometers. This tight integration mitigates external parasitic capacitances and maximizing signal-to-noise ratios during high-speed transitions. Alternative embodiments might employ dispersive gate reflectometry to read out the qubit dots (325) directly, though the proximal charge sensor dots (324) have high-fidelity low-frequency conductance properties. Certain deployments rely on this structural union to rapidly characterize spin and permutation symmetries within few-charge-carrier regimes.

In an embodiment, a controller (317) electrically coupled to the quantum dot device (217) controls voltage generation, data acquisition, and execution of subsequent algorithmic logic. The controller (317) rapidly transmits driving signals directly into the active semiconductor architecture while synchronously ingesting the resulting measurement streams. This conductive communication pathway minimizes latency between physical adjustments and empirical assessments. The controller (317) can comprise various microprocessors, field-programmable gate arrays, or specialized application-specific integrated circuits with sufficient memory to buffer localized sweeps. In an embodiment, operators rely on the controller (317) to interpret global target states and translate those objectives into granular nanosecond-scale gate potential adjustments.

In an embodiment, a ray measurement unit (331) electrically coupled to the controller (317) executes the one-dimensional measurement trajectories. Within this unit, a voltage controller (332.2) generates precise voltage signals to adjust one or more gate electrodes while a data acquisition unit (333.2) records the corresponding output of the charge sensor dots (324). This localized architecture isolates the task of executing rapid directional sweeps from the navigational decision-making processes handled by the controller (317). Certain embodiments use high-bandwidth digital-to-analog converters within the voltage controller (332.2) and digitizers within the data acquisition unit (333.2). An automated laboratory suite leverages the ray measurement unit (331) to sweep a specific gate vector across a twenty-millivolt span in microseconds to locate an isolated polarization line without mapping the entire parameter space.

In an embodiment, a two-dimensional measurement unit (330) electrically coupled to the controller (317) generates comprehensive planar maps capturing global state topologies. Within this unit, a voltage controller (332.1) generates precise voltage signals to adjust one or more gate electrodes while a data acquisition unit (333.1) records the corresponding output of the charge sensor dots (324). By mapping a broader two-dimensional voltage space, the two-dimensional measurement unit (330) supplies baseline data when the system first initializes or when the localized linear sweeps encounter ambiguity. This capacity establishes ground truth for subsequent machine learning evaluations. Variations might implement direct current transport measurements or leverage radio-frequency reflectometry techniques to rapidly construct the required charge stability diagrams. During initial bootstrapping, the two-dimensional measurement unit (330) scans a wide potential range to supply the raw image data needed to properly calibrate the overarching safety limits.

In an embodiment, the spurious quantum dot detection module (301) electrically coupled to the controller (317) actively evaluates empirical measurement streams to identify the presence of anomalous, unintended charge-trapping potential wells. It examines the extracted transition features and specifically flags nonlinear or nonmonotonic boundary crossings that signify defect-driven localizations. Flagging these insidious defects constitutes a practical application by preventing the subsequent logic routines from fruitlessly attempting to tune a severely compromised physical node. The spurious quantum dot detection module (301) might route control back to an overarching state tuner (249) when it decisively identifies a physical defect. In an embodiment, this module protects the algorithmic integrity of the tuning sequence by rigorously vetoing any operational sub-domain polluted by interface defects or surface roughness.

In an embodiment, a quantum dot device unloading module (302) electrically coupled to the controller (317) executes a systematic reduction in the resident charge carrier occupancy. The quantum dot device unloading module (302) iteratively steps the driving potentials toward more negative (positive) values for electrons (holes), sweeping the physical parameter space until specific transition peaks no longer appear. This iterative ejection delivers improved functionality by establishing a neutral electrostatic baseline before any complex multivariable tuning begins. One can program the quantum dot device unloading module (302) to adjust voltages concurrently or to sweep sequentially along alternating axes until a specific termination criterion emerges. A pristine quantum processor uses this precise evacuation to reliably clear all trapped charge carriers following a disruptive thermal cycle.

In an embodiment, an empty quantum dot check module (303) electrically coupled to the controller (317) unequivocally verifies that the solid-state architecture rests within a vacuum state devoid of mobile charge carriers. The empty quantum dot check module (303) directs validation sweeps into the depletion regime to mathematically verify the total absence of transition signatures. This verification loop prevents the tuning logic from building a target state upon a hidden, residual charge carrier. Should residual peaks emerge, the empty quantum dot check module (303) adjusts the coordinate frame using the heuristic voltage adjustment unit (315) and reactivates the prior evacuation logic. This strict mathematical validation ensures that the zero-charge baseline remains uncontaminated prior to the intricate initialization of quantum information nodes.

In an embodiment, the virtualization enabling module (304) electrically coupled to the controller (317) algorithmically navigates the active operational point directly toward a highly localized region enclosing the first charge transitions. The virtualization enabling module (304) relies upon dynamic one-dimensional sweeps to rapidly recenter the measurement origin near the precise intersection where fundamental charge carrier loading initiates using the heuristic voltage adjustment unit (315). By localizing the coordinate frame precisely at this fundamental nexus, the virtualization enabling module (304) provides a solution to the persistent problem of global capacitance variations. Implementations might use alternating step-and-measure loops to iteratively close the distance to the target boundaries. The system relies on this module to securely position the controller within a tight operational envelope where localized linear approximations remain mathematically valid.

In an embodiment, a virtual gate calibration module (305) electrically coupled to the controller (317) determines specific linear combinations of physical gate voltage changes to reduce effective capacitive crosstalk. The virtual gate calibration module (305) derives these mathematical corrections by analyzing the geometric slopes of the charge transitions discovered near the absolute depletion boundaries. Deriving these localized transformation matrices offers superior performance metrics by decoupling the control axes, allowing a single conceptual gate to tune one specific electrochemical potential without inadvertently altering its neighbor. Alternative designs might calculate the cross-capacitance values through multidimensional regression or via simplified neural network inferences. In an embodiment, the virtual gate calibration module (305) repeatedly feeds these updated matrices to the central logic to maintain orthogonal control despite slow thermal drifting.

In an embodiment, the quantum dot loading device module (306) electrically coupled to the controller (317) systematically increases the charge occupancy to actively construct a specific target charge carrier configuration. The quantum dot loading device module (306) translates numerical target states into discrete voltage steps executed strictly within the newly derived virtual gate space. This controlled injection loads exact carrier numbers without accidentally crossing adjacent charge-state boundaries. In an embodiment, the module employs sequential loading strategies targeting one node at a time. In an embodiment, it initiates parallel loading vectors traversing multiple virtual axes simultaneously. In an embodiment, an operator invokes the quantum dot loading device module (306) to deposit two charge carriers into the left well and one charge carrier into the right well to prepare an asymmetric spin cluster.

In an embodiment, an occupancy check module (307) electrically coupled to the controller (317) performs a conclusive validation sequence to verify whether the final intended charge carrier occupancy has been successfully achieved. The occupancy check module (307) triggers a final set of comprehensive measurement sweeps extending back toward the depletion regime to explicitly count the number of crossed transition boundaries. This rigorous final accounting provides an absolute fidelity of the terminal state before releasing the hardware for active quantum operations. If the counted transitions diverge from the initial target, the occupancy check module (307) can abort the operation and re-initiate the entire evacuation and tuning cycle. Research facilities can depend upon the occupancy check module (307) to ensure their intricate logic gates operate upon the exact particle permutations dictated by the theoretical algorithms. If the counted transitions agree with the initial target, the final initialization of the virtual gate calibration module (305) ensures fine-tuned orthogonal control in the target state.

In an embodiment, the spurious quantum dot detection module (301) combines a machine learning system (326), a fitting unit (328), and a domain heuristics unit (310) to interrogate acquired stability diagrams. The machine learning system (326) actively extracts nuanced feature data (327.1) from a two-dimensional scan, after which the fitting unit (328) mathematically processes this extracted information to yield precise fitted feature data (329.1). To ascertain the presence of anomalous localized states, the domain heuristics unit (310) subsequently applies physics-informed rules directly to the fitted feature data (329.1). In an embodiment, different software frameworks deploy varied regression and machine learning techniques within the fitting unit (328), while the overarching logic remains dedicated to isolating nonmonotonic transition behaviors indicative of unintended charge traps. System architects can deploy this integration to rapidly flag defective operational regimes, returning control to an overarching state tuner (249) before subsequent autonomous routines fall prey to capacitive distortions.

In an embodiment, the ray measurement unit (331) integrates a radio-frequency reflectometry unit (335) or a low-frequency conductance measurement unit (336) to probe broad potential landscapes. The low-frequency conductance measurement unit (336) extracts high-fidelity signals through direct current transport, whereas the radio-frequency reflectometry unit (335) reflects dispersive microwave signals off gate electrodes for ultra-fast state readouts. This technological duality provides enhanced performance, delivering measurement speeds and resolution flexibility depending on the specific cryogenic setup. Various embodiments can include dispersive readouts to minimize thermal dissipation.

In an embodiment, the controller (317) structurally incorporates a microprocessor coupled with a memory to manage algorithmic operations. Executing encoded instructions stored within the memory, the microprocessor orchestrates intricate voltage generation, synchronizes data acquisition, and actively implements the logic governing automated tuning sequences. This computational foundation empowers the autonomous framework to adaptively alter tuning strategies and optimization routines without human intervention. Alternative processor architectures might leverage dedicated field-programmable gate arrays to accelerate specific tensor operations, yet the foundational interplay between a central calculating unit and localized instruction storage remains effective. Operators rely completely upon the integrated microprocessor and memory to guide the navigation apparatus through vast parameter spaces over protracted experimental runs.

In an embodiment, the charge sensor dots (324) physically embody highly sensitive local electrometers, which can manifest as a quantum point contact or a single-charge-carrier transistor. These nanoscale structures react to variations in the local electrostatic environment, providing an immediate electrical readout correlated with discrete changes in proximal charge carrier occupancy. Deploying a quantum point contact or a single-charge-carrier transistor provides measurement fidelity at cryogenic temperatures. While specific fabrication geometries can depend on overarching array designs, the reliance upon quantum-confined current modulation persists. One can use the charge sensor dots (324) to track individual-charge-carrier movements during the initialization and operation of high-fidelity solid-state qubits.

In an embodiment, the charge sensor dots (324) are integrated onto a common chip natively alongside the quantum dot device (217). This dense monolithic integration minimizes the physical distance separating the sensing electrometer from the active qubit dots (325), directly magnifying the electrostatic coupling. This arrangement performs measurements more reliably, suppressing parasitic environmental noise that typically corrupts off-chip signal lines. Alternatively, certain manufacturing processes might fabricate the sensors as a separate component subsequently bonded to the main device chip. Foundries can exploit this monolithic integration to provide pristine signal-to-noise ratios across vast, scalable crossbar networks deployed in fault-tolerant quantum computers.

In an embodiment, the two-dimensional measurement unit (330) integrates a radio-frequency reflectometry unit (335) or a low-frequency conductance measurement unit (336) to map broad potential landscapes. The low-frequency conductance measurement unit (336) extracts high-fidelity topological maps through direct current transport, whereas the radio-frequency reflectometry unit (335) reflects dispersive microwave signals off gate electrodes for ultra-fast state readouts. This technological duality provides enhanced performance, delivering measurement speeds and resolution flexibility depending on the specific cryogenic setup. Various embodiments can include dispersive readouts to minimize thermal dissipation. One can use the low-frequency conductance measurement unit (336) to capture charge stability diagrams for accurately discerning complex double-dot topologies.

In an embodiment, the machine learning system (326) employs a U-Net-based architecture or a convolutional neural network (337) to perform pixel classification upon the acquired charge stability diagrams. The U-Net-based architecture or a convolutional neural network (337) rapidly ingests spatial imagery to accurately classify discrete pixels as belonging to various transition classes or polarization lines. Leveraging this deep learning architecture bypasses fragile conventional pattern matching to reliably extract high-level topological features despite synthetic or experimental noise. Alternative machine learning models can include support vector machines or random forests. One can deploy this neural architecture to flawlessly parse massive experimental datasets generated across industrial semiconductor process lines, ensuring accurate virtual gate calibration even under suboptimal sensing conditions.

The ray-based single charge carrier navigation and virtualization apparatus departs from conventional calibration paradigms that exhaustively map multi-dimensional voltage spaces. Practitioners conventionally rely upon massive two-dimensional charge stability diagrams to decipher the global state topology of complex semiconductor architectures. The ray-based single charge carrier navigation and virtualization apparatus circumvents this computational bottleneck by deploying sparse, targeted one-dimensional measurement trajectories. These streamlined electrical probes rigorously probe specific directional vectors within the broader parameter space, capturing localized physical responses while ignoring vast tracts of irrelevant baseline noise. This reduction in necessary data acquisition provides superior measurement speeds and enables highly scalable characterization routines that evade the temporal pitfalls of exhaustive spatial mapping.

The ray-based single charge carrier navigation and virtualization apparatus provides a synergistic amalgamation of advanced pixel classification and rigorous physics-informed logic. The spurious quantum dot detection module seamlessly unites a sophisticated machine learning system with a dedicated fitting module and a domain heuristics module to actively interrogate the active electrical landscape. Standard convolutional neural networks frequently fail when confronted with out-of-distribution device behavior or anomalous defect-driven potential wells. By explicitly translating high-level abstracted feature data into mathematically parameterized linear segments, the system forcefully applies strict geometric rules to immediately identify nonmonotonic transition behaviors. Identifying anomalous defect signatures before subsequent logic routines collapse solves a problem that routinely paralyzes conventional autonomous tuning frameworks.

The methodology executing the decoupling of capacitive control axes represents an architectural leap. Rather than attempting to estimate cross-capacitance metrics from an arbitrary operational coordinate, the virtualization enabling module drives the localized coordinate frame directly toward an intersection of primary charge transitions. Securing this operating point ensures that subsequent calculations reflect the electrostatic boundaries governing initial charge carrier accumulation. The virtual gate calibration module then executes a regression analysis upon the localized boundaries to derive linear combinations of physical gate voltages. This derivation of orthogonalized control axes intrinsic to the primary depletion boundary provides a robust solution to mitigating parasitic capacitive crosstalk across dense qubit arrays.

The innovative sequence performs the lifecycle of state generation and provides efficacy for the architecture. After an automated evacuation of all resident carriers, the empty quantum dot check module algorithmically interrogates the parameter space to guarantee a pristine vacuum state. Validating the absence of residual trapped charges sets a mathematical foundation for the subsequent targeted injection phases. The quantum dot loading device module then steps the potentials along the newly established decoupled axes to populate the specific target nodes. Concluding this progression, the occupancy check module independently validates the terminal distribution, and the virtual gate calibration module ensures fine-tuned orthogonal control in the target state. This coupled chain of events elevates the entire calibration sequence beyond a mere collection of disparate analytical tools, resulting in a reliable system that autonomously operates solid-state quantum computation.

In an embodiment, a process for autonomously tuning a quantum dot device using ray-based measurements comprises acquiring via 2D measurement unit (330) a first 2D quantum dot device measurement data (319.1) representing spatial charge stability from a quantum dot device (217) having qubit dots (325) and charge sensor dots (324); processing the first 2D quantum dot device measurement data (319.1) through a machine learning system (326) to extract feature data (327.1) characterizing physical charge transitions; generating fitted feature data (329.1) by executing a fitting module (328) on the extracted feature data (329.1); detecting an absence of a spurious quantum dot within the quantum dot device (217) by evaluating the fitted feature data (329.1) utilizing domain heuristics (310); driving the quantum dot device (217) via a ray measurement unit (331) to acquire a first set of ray measurement data (321.1) comprising one-dimensional targeted electrical probes; generating peak data from first set of ray measurement data (312.1) from the first set of ray measurement data (321.1) via a peak detection unit (311) to identify an empty state of the quantum dot device (217); acquiring a second set of ray measurement data (321.2) using a ray measurement unit (331); generating peak data (312.2) from the second set of ray measurement data (321.2) using a peak detection unit (311) to confirm that the empty states is achieved using the empty quantum dot check module (303); acquiring a third set of ray measurement data (321.3) using a ray measurement unit (331) and generating peak data from third set of ray measurement data (312.3) from the third set of ray measurement data (321.3) using a peak detection unit (311); navigating to the first set of charge transitions using virtualization enabling module (304); acquiring a second 2D quantum dot device measurement data (319.2) from a quantum dot device (217); extracting feature data from the second 2D quantum dot device measurement data (319.2) using a machine learning system (326); generating fitted feature data from the feature data (329.2) using a fitting module (328); calculating a virtual gate (322) via a virtual gate calibration module (305) based upon an intersection of first charge transitions; modifying a charge carrier occupancy of the quantum dot device (217) by applying voltages along a direction of the virtual gate (322) to load a target charge configuration; and verifying the target charge configuration of the quantum dot device (217) by acquiring a fifth set of ray measurement data (321.5) representing a terminal state of the quantum dot device (217). In an embodiment, the process comprises adjusting a set of gate voltages of the quantum dot device (217) iteratively until the empty state is identified using a quantum dot device unloading module (302). In an embodiment, the process comprises navigating an operating point of the quantum dot device (217) toward the intersection of the first charge transitions using a virtualization enabling module (304) prior to calculating the virtual gate (322). In an embodiment, the process comprises adjusting a set of gate voltages of the quantum dot device (217) iteratively until the target state is identified using a quantum dot device loading module (306).

In an embodiment, the process comprises acquiring the first 2D quantum dot device measurement data (319.1) using a two-dimensional measurement unit (330). In an embodiment, the process comprises executing a radio-frequency reflectometry measurement using the two-dimensional measurement unit (330). In an embodiment, the process comprises routing control to a state tuner (249) when the spurious quantum dot is detected by the domain heuristics (310). In an embodiment, the process comprises determining a plurality of virtual gates (322) as linear combinations of changes applied to physical gate voltages to compensate for capacitive crosstalk. In an embodiment, the process comprises orchestrating data flow between the quantum dot device (217) and the machine learning system (326) using a controller (317). In an embodiment, the process comprises extracting the feature data (327.1) using a U-Net architecture or a convolutional neural network within the machine learning system (326).

The process for autonomously tuning a quantum dot device using ray-based measurements establishes a structured methodological sequence of algorithmic operations executing the automated calibration of localized charge carrier nodes. By avoiding exhaustive multi-dimensional mapping techniques, this operational paradigm leverages targeted linear measurements to chart the active electrostatic boundaries. Acquiring a first 2D quantum dot device measurement data (319.1) from a quantum dot device (217) having qubit dots (325) and charge sensor dots (324) obtains an initial planar map capturing the active electrical landscape. This initial capture grounds subsequent diagnostic analysis, empirically derived directly from the proximal charge sensor dots (324). In an embodiment, a user executes a radio-frequency reflectometry sweep or a low-frequency conductance measurement to instantiate this localized baseline map before proceeding with dynamic navigation.

In an embodiment, extracting feature data (327.1) from the first 2D quantum dot device measurement data (319.1) using a machine learning system (326) processes the raw pixel grids into high-level topological representations. Using a sophisticated deep learning architecture bypasses laborious human inspection protocols. Software frameworks might deploy various U-Net-based architectures or convolutional neural network topologies to isolate the transition boundaries. Generating fitted feature data (329.1) from the feature data (327.1) using a fitting unit (328) translates these pixel clusters into mathematically parameterized segments. This direct geometric parameterization uses numerical modeling to distill raw planar images into numerical slopes and exact spatial coordinates. In an embodiment, this algorithmic distillation rigorously quantifies capacitive interactions embedded within the semiconductor substrate.

In an embodiment, detecting an absence of a spurious quantum dot by applying domain heuristics (310) to the fitted feature data (329.1) mathematically interrogates the parameterized transition slopes to identify anomalous potential wells. Anomalous charge traps manifest as nonmonotonic or distorted transition behaviors diverging from anticipated physical trends. Flagging the presence or explicitly detecting an absence of a spurious quantum dot prevents the automated tuning routines from derailing into defective operational regimes. Acquiring a first set of ray measurement data (321.1) using a ray measurement unit (331) drives single-gate voltage sweeps along designated directional vectors to capture one-dimensional responses. This targeted probing reduces the requisite volume of sampled parameter space compared to conventional planar scanning methodologies. In an embodiment, one alters sweep directions and ray lengths to map specific boundary crossings without accumulating irrelevant baseline noise.

In an embodiment, generating peak data (312.1) from the first set of ray measurement data (321.1) using a peak detection unit (311) parses the isolated one-dimensional signals to accurately pinpoint localized maxima corresponding to specific discrete charge transitions. Pinpointing exact boundary crossings isolates the precise voltage coordinates where individual charge carriers enter or exit the potential well. Identifying an empty state of the quantum dot device (217) from the peak data (312.1) analytically verifies the depletion of all mobile charge carriers. This verification step establishes a zero-charge baseline, guaranteeing reliability by explicitly preventing the system from building operational states upon hidden, residual particles. In an embodiment, one repeatedly probes the parameter space, confirming the absence of transition peaks before commencing qubit loading sequences.

In an embodiment, calculating a virtual gate (322) using a virtual gate calibration module (305) based upon an intersection of first charge transitions computes mathematically derived linear combinations of physical gate voltages. Neutralizing persistent capacitive crosstalk strictly near the primary depletion boundary enables targeted orthogonal control over individual potentials. Modifying a charge-carrier occupancy of the quantum dot device (217) along the direction of the virtual gate (322) to load a target charge configuration steps the driving potentials exactly along these newly defined orthogonal axes. Injecting specified numbers of localized carriers establishes the exact multi-charge-carrier distribution targeted for quantum operation without inadvertently perturbing neighboring electrostatic states. Verifying the target charge configuration of the quantum dot device (217) by acquiring a fifth set of ray measurement data (321.5) executes a conclusive validation sweep. Executing this terminal validation counting sequence provides final operational fidelity before releasing the hardware array for dynamic quantum logic execution.

In an embodiment, adjusting a set of gate voltages of the quantum dot device (217) iteratively until the empty state is identified using a quantum dot device unloading module (302) systematically decreases the resident charge carrier population. This methodical evacuation ensures the semiconductor substrate reaches a vacuum baseline prior to targeted loading. The quantum dot device unloading module (302) repeatedly initiates ray acquisitions and corresponding voltage updates until no transitions are captured within a specified sweep range. Operators apply this iterative depletion to forcefully reset the hardware following anomalous thermal fluctuations or disrupted logic operations. Navigating an operating point of the quantum dot device (217) toward the intersection of the first charge transitions using a virtualization enabling module (304) prior to calculating the virtual gate (322) guarantees that subsequent mathematical parameterizations reflect the foundational electrostatic boundaries. Relocating the coordinate origin toward these primary transitions bypasses the vulnerabilities of attempting to estimate cross-capacitance from an arbitrary, distant locus. The virtualization enabling module (304) executes this shift via a heuristic voltage adjustment unit (315), which initiates a localized feedback process involving a sequence of ray measurements and positional adjustments. A final iteration of the virtual gate calibration module (305) ensures fine-tuned orthogonal control in the terminal charge state.

In an embodiment, acquiring the first 2D quantum dot device measurement data (319.1) using a two-dimensional measurement unit (330) generates a foundational planar map capturing the active electrical landscape. Executing a radio-frequency reflectometry measurement using the two-dimensional measurement unit (330) reflects dispersive microwave signals off gate electrodes for ultra-fast state readouts. This high-bandwidth interrogation delivers enhanced performance, producing superior measurement speeds without subjecting the quantum states to deleterious thermal dissipation. Certain implementations might instead use low-frequency conductance measurements when extreme topological fidelity supersedes temporal constraints. Scientists deploy radio-frequency reflectometry within the two-dimensional measurement unit (330) to rapidly assess global device topologies across massive industrial crossbar networks. Generating the first set of ray measurement data (321.1) by sweeping a single gate voltage along a designated direction in a multi-dimensional gate voltage space while recording a response of the charge sensor dots (324) conserves diagnostic bandwidth. This localized linear probing circumvents the temporal pitfalls of exhaustive spatial mapping by exclusively tracking specific directional vectors. Different testing paradigms alter the magnitude and polarity of the designated direction to sequentially isolate specific boundary crossings. The system uses this streamlined electrical probing to rapidly interrogate specific localized nodes without polluting the overarching data stream with irrelevant baseline noise.

In an embodiment, routing control to a state tuner (249) when the spurious quantum dot is detected by the domain heuristics (310) immediately halts the automated progression to execute corrective physical adjustments. This protective diversion prevents the algorithm from catastrophically failing upon anomalous defect-driven potential wells. The state tuner (249) might alter barrier potentials or entirely shift the active operational domain to circumvent the identified structural defect. System architects rely upon this routing mechanism to insulate delicate autonomous logic sequences from the ubiquitous interface defects routinely plaguing experimental semiconductor fabrication. Determining a plurality of virtual gates (322) as linear combinations of changes applied to physical gate voltages to compensate for capacitive crosstalk establishes an orthogonalized mathematical control space. Compensating for the parasitic capacitive crosstalk directly at the foundational operating point provides control fidelity when manipulating discrete multi-charge-carrier distributions. Implementations determine these precise linear combinations by applying regression analysis to the slopes of the localized charge transition boundaries. In an embodiment, a user can leverage the derived virtual gates (322) to independently adjust individual electrochemical potentials without inadvertently perturbing the delicate quantum states of neighboring information nodes.

In an embodiment, orchestrating data flow between the quantum dot device (217) and the machine learning system (326) using a controller (317) secures a low-latency communication pathway bridging the active physical hardware and the analytical software. Managing this continuous exchange efficiently synchronizes rapid voltage adjustments with deep learning inferences. The controller (317) parses incoming sensor telemetry, buffers the relevant planar images, and transmits them to the predictive models within the machine learning system (326) for immediate classification. This orchestrating capability maintains rigorous timing constraints during nanosecond-scale quantum initialization protocols. Extracting the feature data (327.1 and 327.2) using a U-Net-based architecture or a convolutional neural network (337) within the machine learning system (326) processes raw planar images into high-level topological representations. Processing spatial imagery through a deeply layered neural architecture bypasses fragile conventional pattern matching to reliably classify transition boundaries despite experimental noise. Distinct deployments might alter the number of convolutional layers or adjust pooling strides and residual connections to accommodate varying planar resolutions. Users can integrate the convolutional neural network to flawlessly identify charge transitions and polarization lines across vast datasets captured from varied industrial wafer-scale processors.

In an embodiment, a process for configuring a ray-based single charge carrier navigation apparatus (200) comprises fabricating a quantum dot device (217) having qubit dots (325) and charge sensor dots (324), electrically coupling a controller (317) to the quantum dot device (217), connecting a ray measurement unit (331) to the controller (317), the ray measurement unit (331) including a voltage controller (332.2) and a data acquisition unit (333.2), connecting a two-dimensional measurement unit (330) including a voltage controller (332.1) and a data acquisition unit (333.1) to the controller (317), integrating a spurious quantum dot detection module (301) into the controller (317), integrating a quantum dot device unloading module (302) into the controller (317), integrating an empty quantum dot check module (303) into the controller (317), integrating a virtualization enabling module (304) into the controller (317), integrating a virtual gate calibration module (305) into the controller (317), integrating a quantum dot loading device module (306) into the controller (317), and integrating an occupancy check module (307) into the controller (317). In an embodiment, the process comprises incorporating a machine learning system (326), a fitting unit (328), and a domain heuristics unit (310) into the spurious quantum dot detection module (301). In an embodiment, the process comprises creating the charge sensor dots (324) using beam lithography. In an embodiment, the process comprises creating the charge sensor dots (324) using nanoimprint lithography. In an embodiment, the process comprises fabricating the charge sensor dots (324) onto a common chip with the quantum dot device (217). In an embodiment, the process comprises programming the controller (317) with a set of optimization routines to adapt to specific quantum dot device characteristics. In an embodiment, the process comprises connecting a radio-frequency reflectometry unit (335) to the two-dimensional measurement unit (330). In an embodiment, the process comprises connecting a low-frequency conductance measurement unit (336) to the two-dimensional measurement unit (330). In an embodiment, the process comprises embedding a deep neural network (337) into the machine learning system (326).

In an embodiment, with reference to FIG. 2, consecutive modules are initialized by a signal from a controller (modules 301, 302, 304, 305, and 306) or by a signal passed from a preceding module (modules 303 and 307). The controller (317) originates the following initialization signals: signal 300.1 initializes the spurious quantum dot detection module (301); signal 300.2 initializes the QD device unloading module (302); signal 300.4 initializes the virtualization enabling module (304); signal 300.5 initializes the virtual gate calibration module (305); and signal 300.6 initializes the QD device loading module (306). Furthermore, signal 300.3 transitions from module 302 to initialize the empty QD check module (303), and signal 300.7 transitions from module 306 to initialize the occupancy check module (307).

Upon initialization by the controller (317), these operational modules transmit data requests to one of two measurement units. Modules 301 and 305 specifically direct 2D measurement data requests (first request 318.1 and second request 318.2) to the 2D measurement unit (330). This 2D measurement unit comprises a voltage controller for 2D scans (332.1) and a data acquisition unit for 2D scans (333.1). Conversely, modules 302, 303, 304, 306, and 307 send ray measurement data requests (first through fifth sets, designated 320.1, 320.2, 320.3, 320.4, and 320.5) to the ray measurement unit (331). The ray measurement unit encompasses a voltage controller for rays (332.2) and a data acquisition unit for rays (333.2).

The sequential processing flow of the constituent modules is precisely structured. Initially, the spurious quantum dot detection module (301) transmits the first 2D quantum dot device measurement request (318.1) to the controller (317). Upon receiving the first 2D quantum dot device measurement data (319.1), the module processes this data through a machine learning system (326) to generate feature data (327.1). This feature data (327.1) then undergoes processing within a fitting module (328) to produce fitted feature data (329.1), which the domain heuristics module (310) uses to determine the presence of spurious dots. If spurious dots are detected, a state tuner (249) is initialized. If no spurious dots are found, the controller (317) initializes the QD device unloading module (302).

The quantum dot device unloading module (302) then transmits the first set of ray measurement data request (320.1) to the controller (317). Following the receipt of the first set of ray measurement data (321.1), the module directs this data through a peak detection unit (311) to yield peak data (312.1). Utilizing this peak data (312.1), a charge carrier occupancy decrease module (313) decreases the charge carrier occupancy, and subsequently, signal (300.3) initializes the empty QD check module (303).

Next, the empty quantum dot check module (303) sends the second set of ray measurement data request (320.2) to the controller (317). It receives the second set of ray measurement data (321.2) and processes it via the peak detection unit (311) to generate peak data (312.2). If this peak data (312.2) reveals detected peaks, a heuristic voltage adjustment unit (315) adjusts the measurement position, followed by the re-initialization of the quantum dot device unloading module (302). However, if no peaks are detected in data (312.2), the controller (317) initializes the virtualization enabling module (304).

The virtualization enabling module (304) issues the third set of ray measurement data request (320.3) to the controller (317) and subsequently receives the third set of ray measurement data (321.3). This data is processed through the peak detection unit (311) to create peak data (312.3). The detection of peaks within data (312.3) prompts the controller (317) to initialize the virtual gate calibration module (305). Conversely, an absence of peaks in data (312.3) triggers a heuristic voltage adjustment module (315) to navigate the measurement position closer to the set of first charge transitions, subsequently re-initializing the virtualization enabling module (304).

Following this, the virtual gate calibration module (305) sends the second 2D quantum dot device measurement request (318.2) to the controller (317). After receiving the second 2D quantum dot device measurement data (319.2), the module routes the data through the machine learning system (326) to extract feature data (327.2). The fitting module (328) then processes feature data (327.2) to generate fitted feature data (329.2), establishing the foundation for determining the virtual gates (322).

The quantum dot device loading module (306) then proceeds by sending the fourth set of ray measurement data request (320.4) to the controller (317). It receives the fourth set of ray measurement data (321.4) and passes it through the peak detection unit (311) to produce peak data (312.4). Utilizing this peak data (312.4), a charge carrier occupancy increase module (316) increases the charge carrier occupancy, and signal (300.7) initializes the occupancy check module (307).

Finally, the occupancy check module (307) transmits the fifth set of ray measurement data request (320.5) to the controller (317). It receives the corresponding fifth set of ray measurement data (321.5) and processes it through the peak detection unit (311) to compile peak data (312.5). A charge occupancy confirmation module (314) then utilizes this peak data to verify that the target occupation is achieved. If successful confirmation of charge occupancy occurs, the controller (317) initializes the virtual gate calibration module (305) to execute fine-tuning of the virtual gates within the target charge state. If charge occupancy is not confirmed, the system re-initializes the QD device unloading module (302).

To provide additional background, technical context, and details regarding the physical principles and machine-learning frameworks leveraged by the apparatuses and processes described herein, regarding the automated extraction of feature data, the evaluation of capacitive coupling, and the physics-informed tuning of quantum dot charge states and virtual gate calibrations, the following publications are hereby incorporated by reference in their entireties: Joshua Ziegler, Florian Luthi, Mick Ramsey, Felix Borjans, Guoji Zheng, and Justyna P. Zwolak, “Tuning Arrays with Rays: Physics-Informed Tuning of Quantum Dot Charge States,” Physical Review Applied, Vol. 20, Issue 3, 034067 (September 2023); and Joshua Ziegler, Florian Luthi, Mick Ramsey, Felix Borjans, Guoji Zheng, and Justyna P. Zwolak, “Automated Extraction of Capacitive Coupling for Quantum Dot Systems,” Physical Review Applied, Vol. 19, Issue 5, 054077 (May 2023).

It is contemplated that the machine-learning-driven ray-based navigation and virtualization apparatus can include the properties, functionality, hardware, and process steps described herein and embodied in any of the following non-exhaustive list: a process (e.g., a computer-implemented method including various steps; or a method carried out by a computer including various steps); an apparatus, device, or system (e.g., a data processing apparatus, device, or system including means for carrying out such various steps of the process; a data processing apparatus, device, or system including means for carrying out various steps; a data processing apparatus, device, or system including a processor adapted to or configured to perform such various steps of the process); a computer program product (e.g., a computer program product including instructions which, when the program is executed by a computer, cause the computer to carry out such various steps of the process; a computer program product including instructions which, when the program is executed by a computer, cause the computer to carry out various steps); computer-readable storage medium or data carrier (e.g., a computer-readable storage medium including instructions which, when executed by a computer, cause the computer to carry out such various steps of the process; a computer-readable storage medium including instructions which, when executed by a computer, cause the computer to carry out various steps; a computer-readable data carrier having stored thereon the computer program product; a data carrier signal carrying the computer program product); a computer program product including comprising instructions which, when the program is executed by a first computer, cause the first computer to encode data by performing certain steps and to transmit the encoded data to a second computer; or a computer program product including instructions which, when the program is executed by a second computer, cause the second computer to receive encoded data from a first computer and decode the received data by performing certain steps.

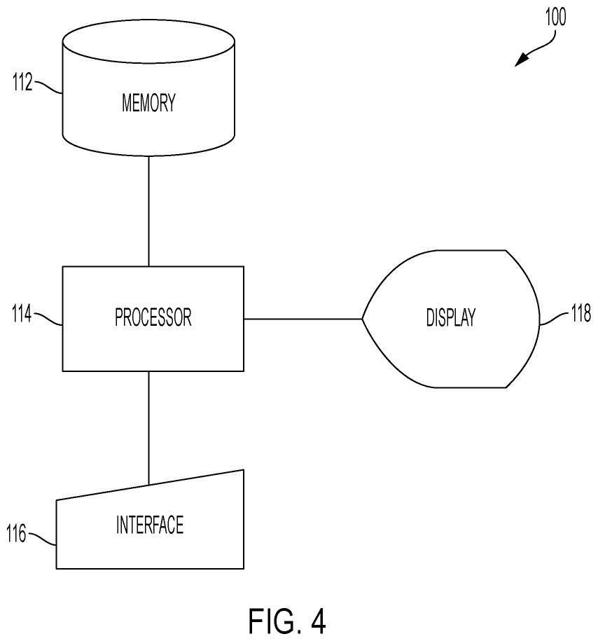

It should be understood that the calculations may be performed by any suitable computer system, such as that diagrammatically shown in FIG. 4. Data is entered into system 100 via any suitable type of user interface 116, and may be stored in memory 112, which may be any suitable type of computer readable and programmable memory and is preferably a non-transitory, computer readable storage medium. Calculations are performed by processor 114, which may be any suitable type of computer processor and may be displayed to the user on display 118, which may be any suitable type of computer display. Processor 114 may be associated with, or incorporated into, any suitable type of computing device, for example, a personal computer or a programmable logic controller. The display 118, the processor 114, the memory 112, and any associated computer-readable recording media are in communication with one another by any suitable type of data bus, as is well known in the art. Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable media include all computer-readable media except for a transitory, propagating signal.

Conventional calibration protocols for complex semiconductor structures depend upon iterative manual adjustments of numerous gate voltages alongside human interpretation of nuanced electrometer data. These procedures are time-consuming, rely upon subjective intuition, and fail to scale to larger arrays operating over extended time periods. Existing automation frameworks attempt to mitigate these immense burdens by executing extensive two-dimensional scans. Such planar mappings demand significant diagnostic bandwidth and produce algorithms that remain brittle in the presence of ambient noise, shifting operating conditions, or unanticipated out-of-distribution device behavior. Device nonidealities, including capacitive crosstalk, stochastic sensor drift, and unintended charge traps, derail these conventional mapping paradigms, leading to tuning failures.

The ray-based single charge carrier navigation and virtualization apparatus 200 replaces exhaustive spatial mapping with highly targeted one-dimensional electrical probes, significantly streamlining the extraction of operational parameters. Rather than passively sweeping entire voltage grids to ascertain topological boundaries, the apparatus implements a specialized sequence combining one-dimensional measurements with machine learning and targeted data-driven analysis to autonomously navigate between distinct operating regimes. A spurious quantum dot detection module 301 actively evaluates data to intercept anomalous behavior, instantly triggering corrective actions to prevent the overarching system from attempting to tune a severely compromised physical node. Conventional frameworks often succumb to these hidden interface defects, whereas the apparatus rigorously polices the active electrical landscape using a combination of neural networks, fitting modules, and domain-specific rules.

The structured progression of operations within the ray-based single charge carrier navigation and virtualization apparatus distinctly diverges from conventional methodologies by strictly enforcing an absolute vacuum baseline before orchestrating any subsequent multidimensional tuning. A quantum dot device unloading module 302 and an empty quantum dot check module 303 sequentially reduce charge carrier occupancy and unequivocally confirm that the solid-state architecture remains entirely devoid of mobile carriers. Following this explicit verification, a virtualization enabling module 304 dynamically shifts the active operating point toward a regime suitable for virtualization. A virtual gate calibration module 305 subsequently determines linear combinations of physical gate voltage changes to neutralize effective capacitive crosstalk, explicitly establishing orthogonal control axes. A quantum dot loading device module 306 safely translates numerical target states into discrete voltage steps executed strictly within the newly derived virtual gate space to achieve a specific charge carrier configuration. An occupancy check module 307 independently validates the exact terminal distribution, completing a highly structured, self-verifying algorithmic progression. Final iteration of the virtual gate calibration module 305 ensures fine-tuned orthogonal control in the target state.

The processes described herein may be embodied in, and fully automated via, software code modules executed by a computing system that includes one or more general-purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware, or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores, or on other parallel architectures, rather than sequentially. In addition, different tasks or processes can be performed by different machines and/or computing systems that can function together.

Any logical blocks, modules, and algorithm elements described or used in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described or used in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix (s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier “about” used in connection with a quantity is inclusive of the stated value and has the meaning dictated by the context (e.g., it includes the degree of error associated with measurement of the particular quantity). The conjunction “or” is used to link objects of a list or alternatives and is not disjunctive, rather the elements can be used separately or can be combined together under appropriate circumstances.

### PARTS LIST

ray-based single charge carrier navigation apparatus 200
quantum dot device 217
state tuner 249
quantum chip and measurement unit 300
initialization of spurious quantum dot detection signal 300.1
initialization of QD device unloading signal 300.2
initialization of empty QD check signal 300.3
initialization of virtualization enabling signal 300.4
initialization of virtual gate calibration signal 300.5
initialization of QD device loading signal 300.6
initialization of occupancy check signal 300.7
spurious quantum dot detection module 301
QD device unloading module 302
empty QD check module 303
virtualization enabling module 304
virtual gate calibration module 305
QD device loading module 306
occupancy check module 307
domain heuristics unit 310
peak detection unit 311
peak data from first set of ray measurement data 312.1
peak data from second set of ray measurement data 312.2
peak data from third set of ray measurement data 312.3
peak data from fourth set of ray measurement data 312.4
peak data from fifth set of ray measurement data 312.5
charge carrier occupancy decrease unit 313
charge occupancy confirmation unit 314
heuristic voltage adjustment unit 315
charge carrier occupancy increase unit 316
controller 317
first 2D quantum dot device measurement request 318.1
second 2D quantum dot device measurement request 318.2
first 2D quantum dot device measurement data 319.1
second 2D quantum dot device measurement data 319.2
first set of ray measurement data request 320.1
second set of ray measurement data request 320.2
third set of ray measurement data request 320.3
fourth set of ray measurement data request 320.4
fifth set of ray measurement data request 320.5
first set of ray measurement data 321.1
second set of ray measurement data 321.2
third set of ray measurement data 321.3
fourth set of ray measurement data 321.4
fifth set of ray measurement data 321.5
virtual gates unit 322
charge sensor dots 324
qubit dots 325
machine learning system 326
first feature data 327.1
second feature data 327.2
fitting unit 328
first fitted feature data 329.1
second fitted feature data 329.2
2D measurement unit 330
ray measurement unit 331
voltage controller for 2D scans 332.1
voltage controller for rays 332.2
data acquisition unit for 2D scans 333.1
data acquisition unit for rays 333.2
radio-frequency reflectometry unit 335
low-frequency conductance measurement unit 336
U-Net-based architecture and or a convolutional neural network 337

What is claimed is:

1. A ray-based single charge carrier navigation apparatus comprising: a quantum dot device having qubit dots and charge sensor dots; a two-dimensional measurement unit comprising a voltage controller and a data acquisition unit configured to acquire spatial stability data from the quantum dot device; a ray measurement unit comprising a voltage controller and a data acquisition unit, configured to execute one-dimensional targeted electrical probes on the quantum dot device; and a controller electrically coupled to the quantum dot device, wherein the controller is configured to initialize the charge carrier navigation and virtualization sequence, with initialization of spurious quantum dot detection signal initializing a spurious quantum dot detection module configured to identify anomalous charge traps based on data from the two-dimensional measurement unit; with initialization of QD device unloading signal initializing a quantum dot device unloading module configured to iteratively adjust voltages via the ray measurement unit to deplete charge carriers from the quantum dot device using the ray measurement unit; with initialization of empty QD check signal initializing an empty quantum dot check module configured to verify a carrier-depleted baseline of the quantum dot device using the ray measurement unit and the heuristic voltage adjustment unit; with initialization of virtualization enabling signal initializing a virtualization enabling module configured to iteratively adjust voltages via the ray measurement unit and the heuristic voltage adjustment unit to bring the coordinate frame near the first set of charge transitions; with initialization of virtual gate calibration signal initializing a virtual gate calibration module configured to derive virtual gates to establish orthogonal control axes for the quantum dot device based on data from the two-dimensional measurement unit; with initialization of QD device loading signal initializing a quantum dot loading device module configured to inject a target charge carrier configuration into the quantum dot device utilizing the established orthogonal control axes and the ray measurement unit; and with initialization of occupancy check signal initializing an occupancy check module configured to validate the target charge carrier configuration utilizing the ray measurement unit.

2. The ray-based single charge carrier navigation and virtualization apparatus of claim 1, wherein the spurious quantum dot detection module includes a machine learning system, a fitting unit, and a domain heuristics unit.

3. The ray-based single charge carrier navigation and virtualization apparatus of claim 1, wherein the 2D measurement unit includes a voltage controller for 2D scans and a data acquisition unit for 2D scans.

4. The ray-based single charge carrier navigation and virtualization apparatus of claim 1, wherein the ray measurement unit includes a voltage controller for rays and data acquisition unit for rays.

5. The ray-based single charge carrier navigation and virtualization apparatus of claim 1, wherein the controller includes a microprocessor and a memory.

6. The ray-based single charge carrier navigation and virtualization apparatus of claim 1, wherein the charge sensor dots include a quantum point contact.

7. The ray-based single charge carrier navigation and virtualization apparatus of claim 1, wherein the charge sensor dots include a single-electron transistor.

8. The ray-based single charge carrier navigation and virtualization apparatus of claim 1, wherein the charge sensor dots are integrated onto a common chip with the quantum dot device.

9. The ray-based single charge carrier navigation and virtualization apparatus of claim 1, wherein the two-dimensional measurement unit and the ray measurement unit include a radio-frequency reflectometry unit.

10. The ray-based single charge carrier navigation and virtualization apparatus of claim 1, wherein the two-dimensional measurement unit and the ray measurement unit include a low-frequency conductance measurement unit.

11. The ray-based single charge carrier navigation and virtualization apparatus of claim 1, wherein the machine learning system includes a U-Net-based architecture or a convolutional neural network.

12. A process for autonomously tuning a quantum dot device using ray-based measurements, comprising: acquiring a first 2D quantum dot device measurement data representing spatial stability from a quantum dot device having qubit dots and charge sensor dots; processing the first 2D quantum dot device measurement data through a machine learning system to extract feature data characterizing physical charge transitions; generating fitted feature data by executing a fitting unit on the extracted feature data; detecting an absence of a spurious quantum dot within the quantum dot device by evaluating the fitted feature data utilizing domain heuristics; driving the quantum dot device via a ray measurement unit to acquire a first set of ray measurement data comprising one-dimensional targeted electrical probes; generating peak data from the first set of ray measurement data via a peak detection unit to identify an empty state of the quantum dot device; confirming that an empty state has been reached using a second set of ray measurement data and generating peak data from the second set of ray measurement data via a peak detection unit; shifting the coordinate frame near a set of first charge transitions using the virtualization enabling module via a third set of ray measurement data and a peak detection unit; calculating a virtual gate via a virtual gate calibration module based upon a second 2D quantum dot device measurement acquired at an intersection of first charge transitions and processed through a machine learning system to extract feature data characterizing physical charge transitions and generating fitted feature data by executing a fitting module on the extracted feature data; modifying a charge carrier occupancy of the quantum dot device by acquiring fourth set of ray measurements and applying voltages along a direction of the virtual gate to load a target charge configuration; verifying the target charge configuration of the quantum dot device by acquiring a fifth set of ray measurement data representing a terminal state of the quantum dot device; and fine-tuning orthogonal control in the target state through one more iteration of the virtual gate calibration module.

13. The process for autonomously tuning a quantum dot device using ray-based measurements of claim 12, comprising adjusting a set of gate voltages of the quantum dot device iteratively until the empty state is identified using a quantum dot device unloading module.

14. The process for autonomously tuning a quantum dot device using ray-based measurements of claim 12, comprising navigating an operating point of the quantum dot device toward the intersection of the first charge transitions using a virtualization enabling module prior to calculating the virtual gate.

15. The process for autonomously tuning a quantum dot device using ray-based measurements of claim 12, comprising acquiring the first 2D quantum dot device measurement data using a two-dimensional measurement unit.

16. The process for autonomously tuning a quantum dot device using ray-based measurements of claim 15, comprising executing a radio-frequency reflectometry measurement using the two-dimensional measurement unit.

17. The process for autonomously tuning a quantum dot device using ray-based measurements of claim 12, comprising generating the first set of ray measurement data by sweeping a single gate voltage along a designated direction in a multi-dimensional gate voltage space while recording a response of the charge sensor dots.

18. The process for autonomously tuning a quantum dot device using ray-based measurements of claim 12, comprising routing control to a state tuner when the spurious quantum dot is detected by the domain heuristics.

19. The process for autonomously tuning a quantum dot device using ray-based measurements of claim 12, comprising determining a plurality of virtual gates as linear combinations of changes applied to physical gate voltages to compensate for capacitive crosstalk.

20. The process for autonomously tuning a quantum dot device using ray-based measurements of claim 12, comprising orchestrating data flow between the quantum dot device and the machine learning system using a controller.

21. The process for autonomously tuning a quantum dot device using ray-based measurements of claim 12, comprising extracting the feature data using a U-Net based architecture or a convolutional neural network within the machine learning system.
